(19) United States
(12) Patent Application Publication
(10) Pub. No.: US 2013/0235597 A1
(43) Pub. Date: Sep. 12, 2013

(54) CUP-SHAPED HEAT DISSIPATION MEMBER APPLICABLE IN ELECTRIC-POWERED LIGHT EMITTING UNIT

(71) Applicant: Tai-Her YANG, Dzan-Hwa (TW)

(72) Inventor: Tai-Her YANG, Dzan-Hwa (TW)

(21) Appl. No.: 13/554,014

(22) Filed: Jul. 20, 2012

Related U.S. Application Data
(63) Continuation-in-part of application No. 13/417,393, filed on Mar. 12, 2012.

(51) Int. Cl. F21V 29/00

(52) U.S. Cl. 362/382

(57) ABSTRACT

The present invention provides a novel cup-shaped heat dissipater structure for meeting the heat dissipation requirement of an electric luminous body; the outer cup bottom of the cup-shaped heat dissipater (100) is formed as a planar or convex or concave surface for accommodating the electric luminous body (200), so the heat generated by the electric luminous body (200) can be dissipated to the exterior from the surface of the heat dissipater, with the enlarged inner recessed surface formed on the cup-shaped structure in the heat dissipater (100) opposite to the installation location of the electric luminous body (200), the heat inside the heat dissipater (100) can also be directly dissipated through the larger heat dissipation area formed on the inner recessed surface of the cup-shaped structure, thereby assisting the electric luminous body (200) to dissipate heat to the exterior.

### CROSS-REFERENCE TO RELATED APPLICATION

This application is a Continuation-In-Part of my patent application Ser. No. 13/417,393, filed on Mar. 12, 2012.

### BACKGROUND OF THE INVENTION

(a) Field of the Invention

The present invention provides a novel cup-shaped heat dissipater structure for meeting the heat dissipation requirement of an electric luminous body, e.g. the heat dissipation requirement of a light emitting diode (LED) which is adopted as the electric luminous body (200); the outer cup bottom of the cup-shaped heat dissipater (100) is formed as a planar or convex or concave surface for accommodating the electric luminous body (200), so the heat generated by the electric luminous body (200) can be dissipated to the exterior from the surface of the heat dissipater, with the enlarged inner recessed surface formed on the cup-shaped structure in the heat dissipater (100) opposite to the installation location of the electric luminous body (200), the heat inside the heat dissipater (100) can also be directly dissipated through the larger heat dissipation area formed on the inner recessed surface of the cup-shaped structure, thereby assisting the electric luminous body (200) to dissipate heat to the exterior.

(b) Description of the Prior Art

A conventional heat dissipation device applicable in the electric luminous body (200) of an electric illumination device, e.g. the heat dissipater used in a LED illumination device, usually transmits the heat generated by the LED to the heat dissipater then dissipates the heat to the exterior through the surface of the heat dissipater, thereby limiting the heat dissipation area.

### SUMMARY OF THE INVENTION

A conventional heat dissipation device applicable in the electric luminous body (200) of an electric illumination device, e.g. the heat dissipater used in a LED illumination device, usually transmits the heat generated by the LED to the heat dissipater then dissipates the heat to the exterior through the surface of the heat dissipater, thereby limiting the heat dissipation area; the present invention provides a novel cup-shaped heat dissipater structure for meeting the heat dissipation requirement of an electric luminous body, e.g. the heat dissipation requirement of a light emitting diode (LED) which is adopted as the electric luminous body (200); the outer cup bottom of the cup-shaped heat dissipater (100) is formed as a planar or convex or concave surface for accommodating the electric luminous body (200), so the heat generated by the electric luminous body (200) can be dissipated to the exterior from the surface of the heat dissipater, with the enlarged inner recessed surface formed on the cup-shaped structure in the heat dissipater (100) opposite to the installation location of the electric luminous body (200), the heat inside the heat dissipater (100) can also be directly dissipated through the larger heat dissipation area formed on the inner recessed surface of the cup-shaped structure, thereby assisting the electric luminous body (200) to dissipate heat to the exterior.

### BRIEF DESCRIPTION OF THE DRAWINGS

FIG. 1 is a cross sectional view showing the basic structure of a conventional heat dissipater (100).

FIG. 2 is a top view of FIG. 1.

FIG. 3 is a cross sectional view illustrating the cup-shaped structure formed in the heat dissipater (100) opposite to the installation location of the electric luminous body (200) being formed with a single annular groove structure, according to the present invention.

FIG. 4 is a top view of FIG. 3.

FIG. 5 is a cross sectional view illustrating the cup-shaped structure formed in the heat dissipater (100) opposite to the installation location of the electric luminous body (200) being formed with a multiple annular groove structure, according to the present invention.

FIG. 6 is a top view of FIG. 5.

FIG. 7 is a cross sectional view of the first embodiment of the present invention illustrating the cup-shaped structure formed in the heat dissipater (100) opposite to the installation location of the electric luminous body (200) being formed with a single annular groove and a stepped structure having the higher central column (103) and the lower outer periphery.

FIG. 8 is a top view of FIG. 7.

FIG. 9 is a cross sectional view of the second embodiment of the present invention illustrating the cup-shaped structure formed in the heat dissipater (100) opposite to the installation location of the electric luminous body (200) being formed with a single annular groove and a stepped structure having the lower central column (103) and the higher outer periphery.

FIG. 10 is a top view of FIG. 9.

FIG. 11 is a cross sectional view of the third embodiment of the present invention illustrating the cup-shaped structure formed in the heat dissipater (100) opposite to the installation location of the electric luminous body (200) being formed with multiple annular grooves (104) and a multiple stepped structure having the higher central column (103) and the lower outer periphery.

FIG. 12 is a top view of FIG. 11.

FIG. 13 is a schematic lateral view of the first embodiment of the present invention illustrating the upper periphery of the cup-shaped structure formed in the heat dissipater (100) opposite to the installation location of the electric luminous body (200) being formed with a crown-like tooth notch (105) and formed with a central column (103).

FIG. 14 is a top view of FIG. 13.

FIG. 15 is another schematic lateral view of the second embodiment of the present invention illustrating the upper periphery of the cup-shaped structure formed in the heat dissipation member (100) opposite to the installation location of the electric-powered light emitting unit (200) being formed with multiple crown-like tooth notch (105) and a structure having the higher central column (103) and the lower outer periphery.

FIG. 16 is a top view of FIG. 15.

FIG. 17 is a cross sectional view illustrating the heat dissipater (100) opposite to the installation location of the electric luminous body (200) being installed with a conical column member and the cup-shaped structure being formed as a fork-shaped annular structure, according to the present invention.

FIG. 18 is a top view of FIG. 17.

FIG. 19 is a cross sectional view illustrating the interior of the cup-shaped structure formed in the heat dissipater (100) opposite to the installation location of the electric luminous body (200) being installed with a multiple-plate type heat dissipation structure (107), according to the present invention.

FIG. 20 is a top view of FIG. 19.

FIG. 21 is a cross sectional view illustrating the interior of the cup-shaped structure formed in the heat dissipater (100) opposite to the installation location of the electric luminous body (200) being installed with a multiple-column type heat dissipation structure (108), according to one embodiment of the present invention.

FIG. 22 is a top view of FIG. 21.

FIG. 23 is a schematic structural view illustrating the central column (103) being composed as a tubular central column, according to the present invention.

FIG. 24 is a schematic lateral view illustrating the top of the heat dissipater (100) opposite to the installation location of the electric luminous body (200) being additionally installed with a protection net (109), according to one embodiment of the present invention.

FIG. 25 is a schematic lateral view illustrating the top of the heat dissipater (100) opposite to the installation location of the electric luminous body (200) being installed with a top cover (110), and formed with a ventilation port (112) and a support column (111) served for combining and supporting between the top cover (110) and the heat dissipater (100), according to one embodiment of the present invention.

FIG. 26 is a schematic lateral view illustrating the support column (111) served for combining and supporting being installed between the top of the heat dissipater (100) opposite to the installation location of the electric luminous body (200) and the top cover (110), and the periphery of the ventilation port (112) being additionally installed with the protection net (109), according to one embodiment of the present invention.

### DESCRIPTION OF MAIN COMPONENT SYMBOLS

100: Heat dissipater
101: Annular surface of heat dissipater
102: Cup-shaped space
103: Central column
104: Annular groove
105: Tooth notch
106: Fork-shaped annular structure
107: Multiple-plate type heat dissipation structure
108: Multiple-column type heat dissipation structure
109: Protection net
110: Top cover
111: Support column
112: Ventilation port
200: Electric luminous body

### DETAILED DESCRIPTION OF THE PREFERRED EMBODIMENTS

A conventional heat dissipation device applicable in the electric luminous body (200) of an electric illumination device, e.g. the heat dissipater used in a LED illumination device, usually transmits the heat generated by the LED to the heat dissipater then dissipates the heat to the exterior through the surface of the heat dissipater, thereby limiting the heat dissipation area.

The present invention provides a novel cup-shaped heat dissipater structure for meeting the heat dissipation requirement of an electric luminous body, e.g. the heat dissipation requirement of a light emitting diode (LED) which is adopted as the electric luminous body (200); the outer cup bottom of the cup-shaped heat dissipater (100) is formed as a planar or convex or concave surface for accommodating the electric luminous body (200), so the heat generated by the electric luminous body (200) can be dissipated to the exterior from the surface of the heat dissipater (100), with the enlarged inner recessed surface formed on the cup-shaped structure in the heat dissipater (100) opposite to the installation location of the electric luminous body (200), the heat inside the heat dissipater (100) can also be directly dissipated through the larger heat dissipation area formed on the inner recessed surface of the cup-shaped structure, thereby assisting the electric luminous body (200) to dissipate heat to the exterior.

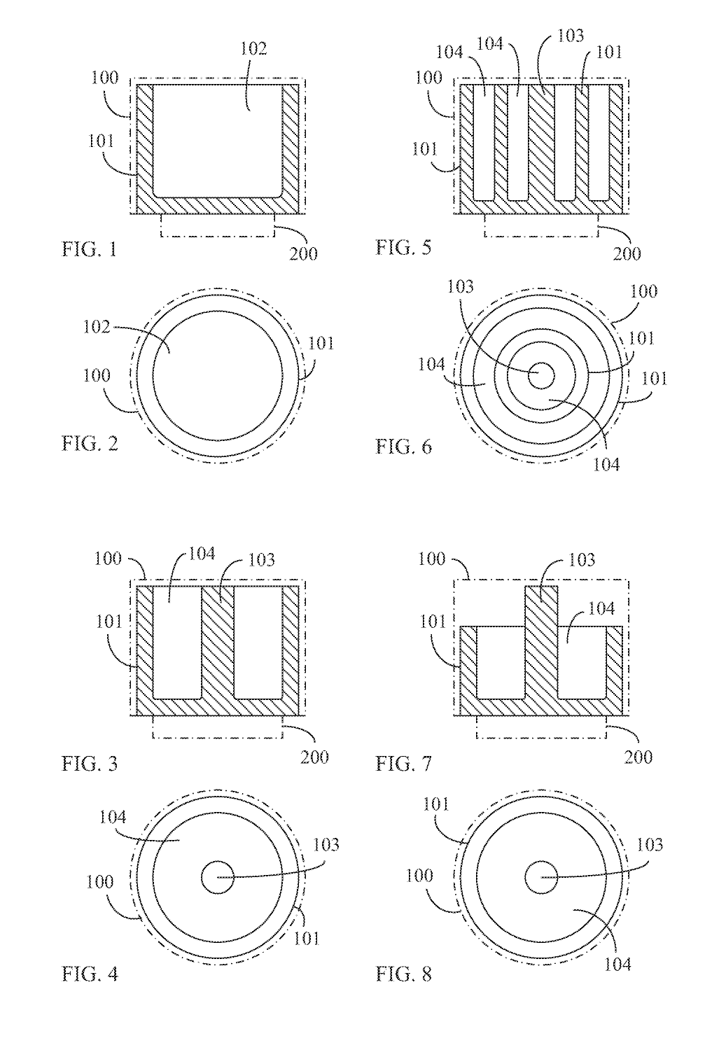

FIG. 1 is a cross sectional view showing the basic structure of a conventional heat dissipater (100);

FIG. 2 is a top view of FIG. 1;

As shown in FIG. 1 and FIG. 2, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be dissipated to the exterior from the surface of the heat dissipater, with the cup-shaped space (102) formed on the cup-shaped inner recessed structure opposite to the installation location of the electric luminous body (200), the heat inside the heat dissipater (100) can also be directly dissipated through the larger heat dissipation area formed on the inner recessed surface of the cup-shaped structure, thereby assisting the electric luminous body (200) to dissipate heat to the exterior.

FIG. 3 is a cross sectional view illustrating the cup-shaped structure formed in the heat dissipater (100) opposite to the installation location of the electric luminous body (200) being formed with a single annular groove structure, according to the present invention;

FIG. 4 is a top view of FIG. 3;

As shown in FIG. 3 and FIG. 4, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein one surface of the heat dissipater (100) is installed with the electric luminous body (200), and the other surface of the heat dissipater (100) is formed with the single annular groove (104) and a solid central column (103) (FIG. 3 is one embodiment formed in the solid state) or a tubular central column (103) (as shown in FIG. 23); the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single annular groove (104) formed on the other surface of the heat dissipater (100), the central column (103) and the annular surface of heat dissipater (101) of the heat dissipater (100), thereby assisting the electric luminous body (200) to dissipate heat to the exterior.

FIG. 5 is a cross sectional view illustrating the cup-shaped structure formed in the heat dissipater (100) opposite to the installation location of the electric luminous body (200) being formed with a multiple annular groove structure, according to the present invention;

FIG. 6 is a top view of FIG. 5;

As shown in FIG. 5 and FIG. 6, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein one surface of the heat dissipater (100) is installed with the electric luminous body (200), and the other surface of the heat dissipater (100) is formed with two or more of the annular grooves (104) and the solid central column (103) (FIG. 5 is one embodiment formed in the solid state) or the tubular central column (103) (as shown in FIG. 23) and two or more layers of the annular surfaces of heat dissipater (101); the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the tow or more of the annular grooves (104) formed on the other surface of the heat dissipater (100), the central column (103) and two or more layers of the annular surfaces of heat dissipater (101), thereby assisting the electric luminous body (200) to dissipate heat to the exterior.

FIG. 7 is a cross sectional view of the first embodiment of the present invention illustrating the cup-shaped structure formed in the heat dissipater (100) opposite to the installation location of the electric luminous body (200) being formed with a single annular groove and a stepped structure having the higher central column (103) and the lower outer periphery;

FIG. 8 is a top view of FIG. 7;

As shown in FIG. 7 and FIG. 8, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single annular groove (104) and a higher central column (103) including the solid central column (103) (FIG. 7 is one embodiment formed in the solid state) or the tubular central column (103) (as shown in FIG. 23), thereby forming a stepped structure having the higher central column (103) and the lower outer periphery; the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single annular groove (104) formed on the other surface of the heat dissipater (100) and the higher solid central column (103) thereby forming a stepped structure having the higher central column (103) and the lower outer periphery, and the annular surface of heat dissipater (101) of the heat dissipater (100), for assisting the electric luminous body (200) to dissipate heat to the exterior.

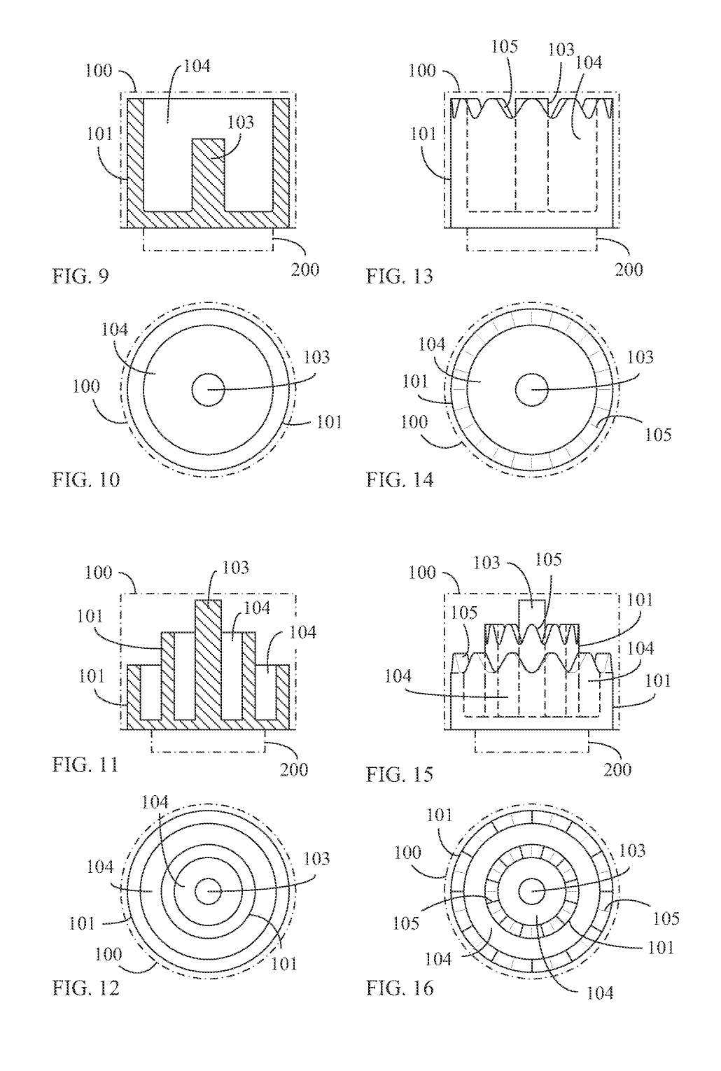

FIG. 9 is a cross sectional view of the second embodiment of the present invention illustrating the cup-shaped structure formed in the heat dissipater (100) opposite to the installation location of the electric luminous body (200) being formed with a single annular groove and a stepped structure having the lower central column (103) and the higher outer periphery;

FIG. 10 is a top view of FIG. 9;

As shown in FIG. 9 and FIG. 10, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single annular groove (104) and a lower central column (103) including the solid central column (103) (FIG. 9 is one embodiment formed in the solid state) or the tubular central column (103) (as shown in FIG. 23), thereby forming a stepped structure having the lower central column (103) and the higher outer periphery; the surface of one or both of the cup periphery and/or the inner annular surface of the heat dissipater (100) is formed as a planar or wavelike structure or formed with a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single annular groove (104) formed on the other surface of the heat dissipater (100) and the lower central column (103) thereby forming a stepped structure having the lower central column (103) and the higher outer periphery, and the annular surface of heat dissipater (101) of the heat dissipater (100), for assisting the electric luminous body (200) to dissipate heat to the exterior.

FIG. 11 is a cross sectional view of the third embodiment of the present invention illustrating the cup-shaped structure formed in the heat dissipater (100) opposite to the installation location of the electric luminous body (200) being formed with multiple annular grooves (104) and a multiple stepped structure having the higher central column (103) and the lower outer periphery;

FIG. 12 is a top view of FIG. 11;

As shown in FIG. 11 and FIG. 12, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with two or more of the annular grooves (104) and the solid central column (103) (FIG. 11 is one embodiment formed in the solid state) or the tubular central column (103) (as shown in FIG. 23), and two or more layers of the annular surfaces of heat dissipater (101), thereby forming a multiple stepped structure having the higher central column (103) and the lower outer periphery; the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by two or more of the annular grooves (104) formed on the other surface of the heat dissipater (100), the central column (103) and two or more layers of the annular surfaces of heat dissipater (101) thereby forming a multiple stepped structure having the higher central column (103) and the lower outer periphery, for assisting the electric luminous body (200) to dissipate heat to the exterior;

the mentioned heat dissipater (100) further includes that the cup-shaped structure formed in the heat dissipater (100) opposite to the installation location of the electric luminous body (200) has two or more of the annular grooves (104) and the central column (103) and two or more layers of the annular surfaces of heat dissipater (101), thereby forming a multiple-stepped structure having the higher outer periphery.

FIG. 13 is a schematic lateral view of the first embodiment of the present invention illustrating the upper periphery of the cup-shaped structure formed in the heat dissipater (100) opposite to the installation location of the electric luminous body (200) being formed with a crown-like tooth notch (105) and formed with a central column (103);

FIG. 14 is a top view of FIG. 13;

As shown in FIG. 13 and FIG. 14, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed the cup-shaped inner recessed structure having an annular structure formed with crown-like tooth notch (105) at the upper periphery and a central column (103) including the solid central column (103) (FIG. 13 is one embodiment formed in the solid state) or the tubular central column (103) (as shown in FIG. 23), and the central column (103) and the annular structure formed with the crown-like tooth notch (105) at the periphery being at the same or different height; the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure having the annular structure formed with the crown-like tooth notch (105) at the upper periphery formed on the other surface of the heat dissipater (100), the central column (103) and the annular surface of heat dissipater (101) of the heat dissipater (100), thereby assisting the electric luminous body (200) to dissipate heat to the exterior;

the multiple annular structure of the mentioned multiple crown-like tooth notches (105) is defined as two or more layers.

FIG. 15 is another schematic lateral view of the second embodiment of the present invention illustrating the upper periphery of the cup-shaped structure formed in the heat dissipation member (100) opposite to the installation location of the electric-powered light emitting unit (200) being formed with multiple crown-like tooth notch (105) and a structure having the higher central column (103) and the lower outer periphery;

FIG. 16 is a top view of FIG. 15;

As shown in FIG. 15 and FIG. 16, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple crown-like tooth notch (105) at the upper periphery and a central column (103) including the solid central column (103) (FIG. 15 is one embodiment formed in the solid state) or the tubular central column (103) (as shown in FIG. 23), thereby forming a multiple annular structure having the higher central column (103) and having the lower crown-like tooth notch (105) at the outer periphery; the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the upper periphery of the cup-shaped inner recessed structure at the other surface of the heat dissipater (100) formed with the multiple annular structure having the higher central column (103) and the lower crown-like tooth notch (105) at the outer periphery and the annular surface of heat dissipater (101) of the heat dissipater (100), thereby assisting the electric luminous body (200) to dissipate heat to the exterior;

the mentioned heat dissipater (100) further includes that the upper periphery of the cup-shaped structure formed in the heat dissipater (100) opposite to the installation location of the electric luminous body (200) has multiple crown-like tooth notches (105) and a central column (103), thereby forming a structure having the lower central column (103) and the higher multiple annular structure having the crown-like tooth notches (105) at the outer periphery;

the multiple annular structure of the mentioned multiple crown-like tooth notches (105) is defined as two or more layers.

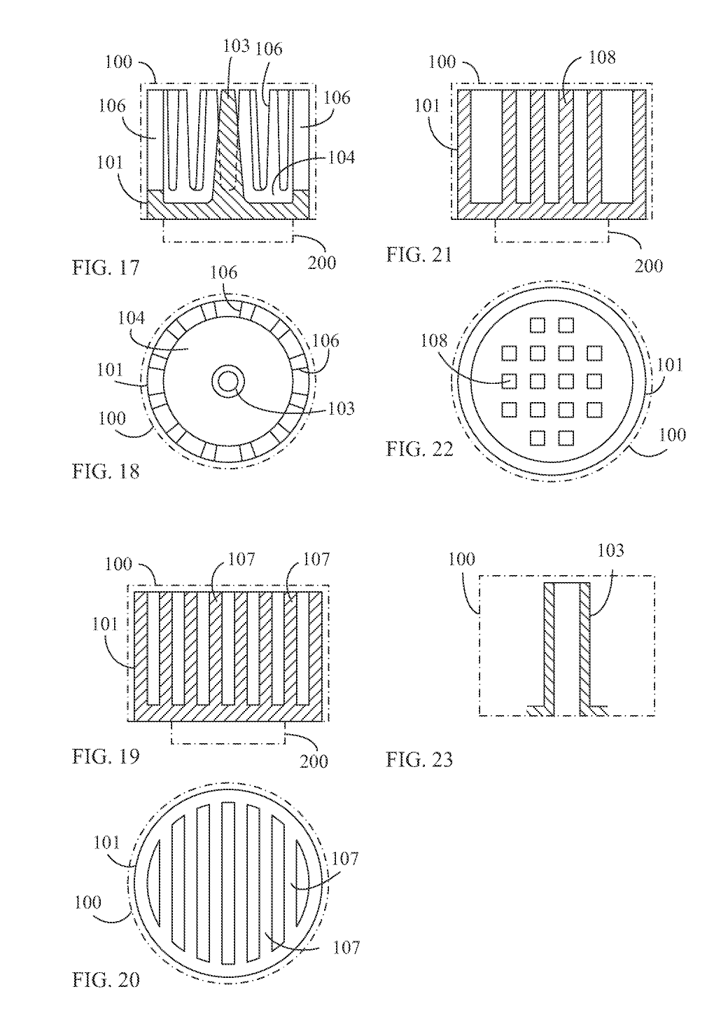

FIG. 17 is a cross sectional view illustrating the heat dissipater (100) opposite to the installation location of the electric luminous body (200) being installed with a conical column member and the cup-shaped structure being formed as a fork-shaped annular structure, according to the present invention;

FIG. 18 is a top view of FIG. 17;

As shown in FIG. 17 and FIG. 18, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the fork-shaped annular structure (106) and the conical central column (103) including the solid central column (103) (FIG. 17 is one embodiment formed in the solid state) or the tubular central column (103) (as shown in FIG. 23); the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure at the other surface of the heat dissipater (100) being formed as the fork-shaped annular structure (106) and installed with the conical central column (103) and the annular surface of heat dissipater (101) of the heat dissipater (100), thereby assisting the electric luminous body (200) to dissipate heat to the exterior.

FIG. 19 is a cross sectional view illustrating the interior of the cup-shaped structure formed in the heat dissipater (100) opposite to the installation location of the electric luminous body (200) being installed with a multiple-plate type heat dissipation structure (107), according to the present invention;

FIG. 20 is a top view of FIG. 19;

As shown in FIG. 19 and FIG. 20, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple-plate type heat dissipation structure (107) therein; the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the inner recessed cup-shaped structure at the other surface of the heat dissipater (100) having the multiple-plate type heat dissipation structure (107) therein and the annular surface of heat dissipater (101) of heat dissipater (100), thereby assisting the electric luminous body (200) to dissipate heat to the exterior.

FIG. 21 is a cross sectional view illustrating the interior of the cup-shaped structure formed in the heat dissipater (100) opposite to the installation location of the electric luminous body (200) being installed with a multiple-column type heat dissipation structure (108), according to one embodiment of the present invention;

FIG. 22 is a top view of FIG. 21;

As shown in FIG. 21 and FIG. 22, it mainly consists of:

heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple-column type heat dissipation structure (108) therein; the surface of one or both of the cup periphery and/or the inner annular surface of the heat dissipater (100) is formed as a planar or wavelike structure or formed as a structure having heat dissipation fins;

the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure at the other surface of the heat dissipater (100) having the multiple-column type heat dissipation structure (108) therein and the annular surface of heat dissipater (101) of heat dissipater (100), thereby assisting the electric luminous body (200) to dissipate heat to the exterior.

According to the cup-shaped heat dissipation member applicable in electric-powered light emitting unit of the present invention, the central column (103) except for being composed of a solid central column, it can be further composed of a tubular central column;

FIG. 23 is a schematic structural view illustrating the central column (103) being composed as a tubular central column, according to the present invention;

As shown in FIG. 23, the central column (103) of the present invention is composed of the tubular central column.

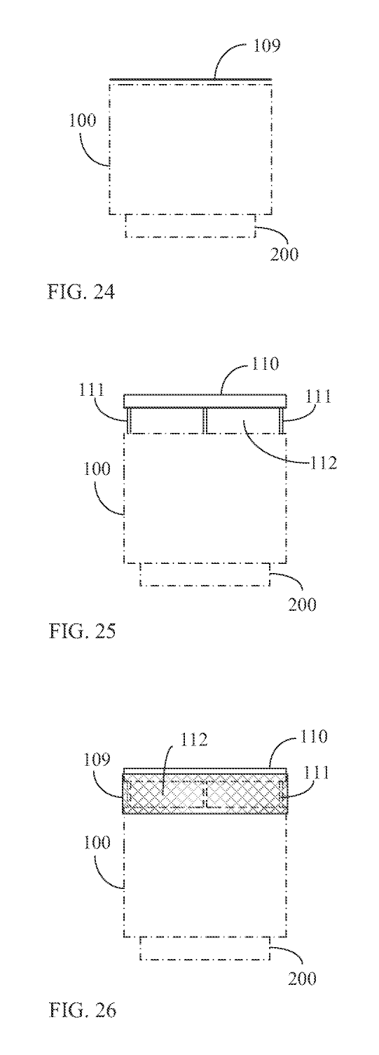

FIG. 24 is a schematic lateral view illustrating the top of the heat dissipater (100) opposite to the installation location of the electric luminous body (200) being additionally installed with a protection net (109), according to one embodiment of the present invention;

As shown in FIG. 24, according to one embodiment of the present invention, the top of the heat dissipater (100) opposite to the installation location of the electric luminous body (200) is additionally installed with the protection net (109).

FIG. 25 is a schematic lateral view illustrating the top of the heat dissipater (100) opposite to the installation location of the electric luminous body (200) being installed with a top cover (110), and formed with a ventilation port (112) and a support column (111) served for connecting and supporting between the top cover (110) and the heat dissipater (100), according to one embodiment of the present invention;

As shown in FIG. 25, according to one embodiment of the present invention, the top of the heat dissipater (100) opposite to the installation location of the electric luminous body (200) is installed with the top cover (110), and formed with the ventilation port (112) and the support column (111) served for connecting and supporting between the top cover (110) and the heat dissipater (100).

FIG. 26 is a schematic lateral view illustrating the support column (111) served for connecting and supporting being installed between the top of the heat dissipater (100) opposite to the installation location of the electric luminous body (200) and the top cover (110), and the periphery of the ventilation port (112) being additionally installed with the protection net (109), according to one embodiment of the present invention;

As shown in FIG. 26, according to one embodiment of the present invention, the support column (111) served for connecting and supporting is installed between the top of the heat dissipater (100) opposite to the installation location of the electric luminous body (200) and the top cover (110), and the periphery of the ventilation port (112) is additionally installed with the protection net (109).

The mentioned electric luminous body (200) according to the cup-shaped heat dissipation member applicable in electric-powered light emitting unit can be further configured by the electric luminous body and optical component and lampshade.

1. A cup-shaped heat dissipation member applicable in electric-powered light emitting unit, wherein the cup-shaped structure formed in the heat dissipater (100) opposite to the installation location of the electric luminous body (200) is formed with a single annular groove structure, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein one surface of the heat dissipater (100) is installed with the electric luminous body (200), and the other surface of the heat dissipater (100) is formed with the single annular groove (104) and a solid central column (103) or a tubular central column (103); the surface of one or both of the cup periphery and/or the inner annular surface of the heat dissipater (100) is formed as a planar or wavelike structure or formed as a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single annular groove (104) formed on the other surface of the heat dissipater (100), the central column (103) and the annular surface of heat dissipater (101) of the heat dissipater (100), thereby assisting the electric luminous body (200) to dissipate heat to the exterior.

2. A cup-shaped heat dissipation member applicable in electric-powered light emitting unit as claimed in claim 1, wherein the cup-shaped structure formed in the heat dissipater (100) opposite to the installation location of the electric luminous body (200) is further formed with a multiple annular groove structure, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours; wherein one surface of the heat dissipater (100) is installed with the electric luminous body (200), and the other surface of the heat dissipater (100) is formed with two or more of the annular grooves (104) and the solid central column (103) or the tubular central column (103) and two or more layers of the annular surfaces of heat dissipater (101); the surface of one or both of the cup periphery and/or the inner annular surface of the heat dissipater (100) is formed as a planar or wavelike structure or formed as a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the tow or more of the annular grooves (104) formed on the other surface of the heat dissipater (100), the central column (103) and two or more layers of the annular surfaces of heat dissipater (101), thereby assisting the electric luminous body (200) to dissipate heat to the exterior.

3. A cup-shaped heat dissipation member applicable in electric-powered light emitting unit as claimed in claim 1, wherein the cup-shaped structure formed in the heat dissipater (100) opposite to the installation location of the electric luminous body (200) is further formed with a single annular groove and a stepped structure having the higher central column (103) and the lower outer periphery, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single annular groove (104) and a higher central column (103) including the solid central column (103) or the tubular central column (103), thereby forming a stepped structure having the higher central column (103) and the lower outer periphery; the surface of one or both of the cup periphery and/or the inner annular surface of the heat dissipater (100) is formed as a planar or wavelike structure or formed as a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single annular groove (104) formed on the other surface of the heat dissipater (100) and the higher solid central column (103) thereby forming a stepped structure having the higher central column (103) and the lower outer periphery, and the annular surface of heat dissipater (101) of the heat dissipater (100), for assisting the electric luminous body (200) to dissipate heat to the exterior.

4. A cup-shaped heat dissipation member applicable in electric-powered light emitting unit as claimed in claim 1, wherein the cup-shaped structure formed in the heat dissipater (100) opposite to the installation location of the electric luminous body (200) is further formed with a single annular groove and a stepped structure having the lower central column (103) and the higher outer periphery, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the single annular groove (104) and a lower central column (103) including the solid central column (103) or the tubular central column (103), thereby forming a stepped structure having the lower central column (103) and the higher outer periphery; the surface of one or both of the cup periphery and/or the inner annular surface of the heat dissipater (100) is formed as a planar or wavelike structure or formed with a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the single annular groove (104) formed on the other surface of the heat dissipater (100) and the lower central column (103) thereby forming a stepped structure having the lower central column (103) and the higher outer periphery, and the annular surface of heat dissipater (101) of the heat dissipater (100), for assisting the electric luminous body (200) to dissipate heat to the exterior.

5. A cup-shaped heat dissipation member applicable in electric-powered light emitting unit as claimed in claim 2, wherein the cup-shaped structure formed in the heat dissipater (100) opposite to the installation location of the electric luminous body (200) is further formed with multiple annular grooves (104) and a multiple stepped structure having the higher central column (103) and the lower outer periphery, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with two or more of the annular grooves (104) and the solid central column (103) or the tubular central column (103), and two or more layers of the annular surfaces of heat dissipater (101), thereby forming a multiple stepped structure having the higher central column (103) and the lower outer periphery; the surface of one or both of the cup periphery and/or the inner annular surface of the heat dissipater (100) is formed as a planar or wavelike structure or formed as a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by two or more of the annular grooves (104) formed on the other surface of the heat dissipater (100), the central column (103) and two or more layers of the annular surfaces of heat dissipater (101) thereby forming a multiple stepped structure having the higher central column (103) and the lower outer periphery, for assisting the electric luminous body (200) to dissipate heat to the exterior;
the mentioned heat dissipater (100) further includes that the cup-shaped structure formed in the heat dissipater (100) opposite to the installation location of the electric luminous body (200) has two or more of the annular grooves (104) and the central column (103) and two or more layers of the annular surfaces of heat dissipater (101), thereby forming a multiple-stepped structure having the higher outer periphery.

6. A cup-shaped heat dissipation member applicable in electric-powered light emitting unit as claimed in claim 1, wherein the upper periphery of the cup-shaped structure formed in the heat dissipater (100) opposite to the installation location of the electric luminous body (200) is further formed with a crown-like tooth notch (105) and formed with a central column (103), and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed the cup-shaped inner recessed structure having an annular structure formed with crown-like tooth notch (105) at the upper periphery and a central column (103) including the solid central column (103) or the tubular central column (103), and the central column (103) and the annular structure formed with the crown-like tooth notch (105) at the periphery being at the same or different height; the surface of one or both of the cup periphery and/or the inner annular surface of the heat dissipater (100) is formed as a planar or wavelike structure or formed as a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure having the annular structure formed with the crown-like tooth notch (105) at the upper periphery formed on the other surface of the heat dissipater (100), the central column (103) and the annular surface of heat dissipater (101) of the heat dissipater (100), thereby assisting the electric luminous body (200) to dissipate heat to the exterior;
the multiple annular structure of the mentioned multiple crown-like tooth notches (105) is defined as two or more layers.

7. A cup-shaped heat dissipation member applicable in electric-powered light emitting unit as claimed in claim 5, wherein the upper periphery of the cup-shaped structure formed in the heat dissipation member (100) opposite to the installation location of the electric-powered light emitting unit (200) is further formed with multiple crown-like tooth notch (105) and a structure having the higher central column (103) and the lower outer periphery, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple crown-like tooth notch (105) at the upper periphery and a central column (103) including the solid central column (103) or the tubular central column (103), thereby forming a multiple annular structure having the higher central column (103) and having the lower crown-like tooth notch (105) at the outer periphery; the surface of one or both of the cup periphery and/or the inner annular surface of the heat dissipater (100) is formed as a planar or wavelike structure or formed as a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the upper periphery of the cup-shaped inner recessed structure at the other surface of the heat dissipater (100) formed with the multiple annular structure having the higher central column (103) and the lower crown-like tooth notch (105) at the outer periphery and the annular surface of heat dissipater (101) of the heat dissipater (100), thereby assisting the electric luminous body (200) to dissipate heat to the exterior;
the mentioned heat dissipater (100) further includes that the upper periphery of the cup-shaped structure formed in the heat dissipater (100) opposite to the installation location of the electric luminous body (200) has multiple crown-like tooth notches (105) and a central column (103), thereby forming a structure having the lower central column (103) and the higher multiple annular structure having the crown-like tooth notches (105) at the outer periphery;
the multiple annular structure of the mentioned multiple crown-like tooth notches (105) is defined as two or more layers.

8. A cup-shaped heat dissipation member applicable in electric-powered light emitting unit as claimed in claim 1, wherein the heat dissipater (100) opposite to the installation location of the electric luminous body (200) is further installed with a conical column member and the cup-shaped structure being formed as a fork-shaped annular structure, and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the fork-shaped annular structure (106) and the conical central column (103) including the solid central column (103) or the tubular central column (103); the surface of one or both of the cup periphery and/or the inner annular surface of the heat dissipater (100) is formed as a planar or wavelike structure or formed as a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure at the other surface of the heat dissipater (100) being formed as the fork-shaped annular structure (106) and installed with the conical central column (103) and the annular surface of heat dissipater (101) of the heat dissipater (100), thereby assisting the electric luminous body (200) to dissipate heat to the exterior.

9. A cup-shaped heat dissipation member applicable in electric-powered light emitting unit as claimed in claim 1, wherein the interior of the cup-shaped structure formed in the heat dissipater (100) opposite to the installation location of the electric luminous body (200) is further installed with a multiple-plate type heat dissipation structure (107), and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple-plate type heat dissipation structure (107) therein; the surface of one or both of the cup periphery and/or the inner annular surface of the heat dissipater (100) is formed as a planar or wavelike structure or formed as a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the inner recessed cup-shaped structure at the other surface of the heat dissipater (100) having the multiple-plate type heat dissipation structure (107) therein and the annular surface of heat dissipater (101) of heat dissipater (100), thereby assisting the electric luminous body (200) to dissipate heat to the exterior.

10. A cup-shaped heat dissipation member applicable in electric-powered light emitting unit as claimed in claim 1, wherein the interior of the cup-shaped structure formed in the heat dissipater (100) opposite to the installation location of the electric luminous body (200) is further installed with a multiple-column type heat dissipation structure (108), and it mainly consists of:
heat dissipater (100): formed as a circular, oval or polygonal cup-shaped or cup-like structure, made of materials having great heat conductivity and heat dissipation property such as aluminum and copper, integrally formed or assembled by plural pieces; including parallel or conical or reverse-conical cup body contours, wherein one surface of the heat dissipater (100) is installed with the electric luminous body (200), and the other surface of the heat dissipater (100) is formed with the cup-shaped inner recessed structure having the multiple-column type heat dissipation structure (108) therein; the surface of one or both of the cup periphery and/or the inner annular surface of the heat dissipater (100) is formed as a planar or wavelike structure or formed as a structure having heat dissipation fins;
the outer cup bottom of the cup-shaped heat dissipater is formed as a planar or convex or concave surface for accommodating the electric luminous body (200), so the heat generated by the electric luminous body (200) can be directly dissipated to the exterior through a larger heat dissipation area defined by the cup-shaped inner recessed structure at the other surface of the heat dissipater (100) having the multiple-column type heat dissipation structure (108) therein and the annular surface of heat dissipater (101) of heat dissipater (100), thereby assisting the electric luminous body (200) to dissipate heat to the exterior.

11. A cup-shaped heat dissipation member applicable in electric-powered light emitting unit, wherein
(a) the top of the heat dissipater (100) opposite to the installation location of the electric luminous body (200) is additionally installed with the protection net (109);
(b) the top of the heat dissipater (100) opposite to the installation location of the electric luminous body (200) is installed with the top cover (110), and formed with the ventilation port (112) and the support column (111) served for connecting and supporting between the top cover (110) and the heat dissipater (100);
(c) both (a) and (b) are installed.
